(19) United States
(12) Patent Application Publication
(10) Pub. No.: US 2005/0282556 A1
(43) Pub. Date: Dec. 22, 2005

(54) Method and system for distributing and collecting location sensitive information over a wireless local area network

(76) Inventor: Robert P. Morris, Raleigh, NC (US)

Correspondence Address: SAWYER LAW GROUP, LLP, PO BOX 51458, PAL ALTO, CA, 94303, US

(21) Appl. No.: 10/869,699

(22) Filed: Jun. 16, 2004

(51) Int. Cl. H04Q 7/20

(52) U.S. Cl. 455/456.1

(57) ABSTRACT

In a first aspect, the present invention is a method that includes specifying on the electronic device a request for a product or service, and receiving in the electronic device advertising information related to a local merchant from the local merchant and transmitted over a wireless local area network (LAN). The method also includes displaying on the electronic device the advertising information if the product or service offered by the local merchant matches the request, whereby the electronic device collects location sensitive information without requiring the electronic device to specify its location. In a second aspect, the present invention is a system that includes a computer system associated with at least one local merchant that is coupled to the wireless LAN and includes at least one advertiser for transmitting over the wireless LAN advertising information related to each of the at least one local merchants. The system also includes an electronic device that is capable of connecting to the wireless LAN. The electronic device includes a locator for connecting the electronic device to the wireless LAN and for receiving the advertising information transmitted by the computer system associated with the at least one merchant, and a display for displaying the advertising information if the product or service offered by the local merchant matches a request from the electronic device for a product or service.

### BACKGROUND OF THE INVENTION

1. Field of the Invention

The present invention relates to electronic devices, and more particularly to distributing and collecting location sensitive information over a wireless local area network.

2. Description of the Related Art

The functionality of mobile handheld electronic devices, such as PDAs and mobile phones, has expanded rapidly with advances in communication technology and processing power. Many such devices allow a user to access wireless networks, so that the user can browse for information via the handheld device. This feature is quite useful when the user is in an unfamiliar location, e.g., as a tourist, and does not have access to a personal computer coupled to the Internet. The user can browse for local merchants or service providers. This process can be tedious and time-consuming because such a search most likely would produce a large number of “hits,” and the user would be required to sift through the information to find a suitable merchant.

In one approach to alleviating this concern, location-based services are available that receive a request from the user for services or goods, determines the geographical location of the handheld device, using for example GPS or some other triangulating technique, and queries a database to determine merchants providing the requested services or goods in the device's vicinity. Location-based services, however, are not available for handheld devices that do not or cannot provide its location information. Moreover, the quality of the service depends on the quality of the database. Because a fee is typically charged to have a listing in the database, some merchants will choose not to list. Another disadvantage of such a service is that the database server is a single point of failure, so that if the database server is not accessible, the service is unavailable.

Another approach to providing location-sensitive information uses facilities available on a local network to which the handheld electronic device has access. Here, such facilities provide directory or lookup type services using technologies such as UPnP and Java's Jini, for example. Nevertheless, such lookup services are typically limited because UPnP and Java Jini are not universally available. Moreover, even if available, neither provide a user interface. In addition, interfaces to directories typically provide limited options with respect to how any given listing in the directory is presented. Thus, the appearance of a listing is controlled by the directory user interface, and not by the merchant associated with the listing.

Accordingly, what is needed is an improved system and method for distributing and collecting location-sensitive information. The system and method should allow a user of an electronic device to receive such information without having to provide location information. The system and method should also allow merchants to control the presentation of their services and products, and should allow merchants to advertise their services and products without an additional listing fee. The present invention addresses such a need.

### BRIEF SUMMARY OF THE INVENTION

The present invention is directed to a method and system for distributing and collecting location sensitive information over a wireless local area network. In a first aspect, the present invention is a method that includes specifying on the electronic device a request for a product or service, and receiving in the electronic device advertising information related to a local merchant from the local merchant and transmitted over a wireless local area network (LAN). The method also includes displaying on the electronic device the advertising information if the product or service offered by the local merchant matches the request, whereby the electronic device collects location sensitive information without requiring the electronic device to specify its location.

In a second aspect, the present invention is a system that includes a computer system associated with at least one local merchant that is coupled to the wireless LAN and includes at least one advertiser for transmitting over the wireless LAN advertising information related to each of the at least one local merchants. The system also includes an electronic device that is capable of connecting to the wireless LAN. The electronic device includes a locator for connecting the electronic device to the wireless LAN and for receiving the advertising information transmitted by the computer system associated with the at least one merchant, and a display for displaying the advertising information if the product or service offered by the local merchant matches a request from the electronic device for a product or service.

In a third aspect, a method for distributing advertising information from a local merchant to a potential customer over a wireless local area network includes receiving by the local merchant a request for a product or service transmitted over the wireless local area network (LAN) by the potential customer, and determining whether a product or service offered by the local merchant matches the request. If such a match is determined, the method includes transmitting advertising information from the local merchant to the potential customer, whereby the advertising information describes the product or service offered by the local merchant and includes a reference to the local merchant.

According to the method and system disclosed herein, the present invention allows a user of the electronic device to gather information regarding local merchants through a wireless local area network. Accordingly, there is no need to provide location information to a third party. Because a local merchant transmits its information independently, the merchant is allowed to present the information as it wishes. Moreover, local merchants can advertise their products and services through their own local networks or through a shared network, thereby eliminating the need (and the associated expense) for a third party directory service.

### BRIEF DESCRIPTION OF SEVERAL VIEWS OF THE DRAWINGS

FIG. 1 is a block diagram illustrating a network environment that can be utilized according to a preferred embodiment of the present invention.

FIG. 2 is a flowchart illustrating a process for collecting location sensitive information according to a first preferred embodiment of the present invention.

FIG. 3 is a flowchart illustrating a process for collecting location sensitive information according to a second preferred embodiment of the present invention.

FIG. 4 is block diagram illustrating a format for a request for location sensitive information according to a preferred embodiment of the present invention.

FIG. 5 is a block diagram illustrating a format for advertising information from a local merchant according to a preferred embodiment of the present invention.

FIG. 6 is a block diagram illustrating information in the reference according to a preferred embodiment of the present invention.

### DETAILED DESCRIPTION OF THE INVENTION

The present invention relates to electronic devices, and more particularly to distributing and collecting location sensitive information over a wireless local area network. The following description is presented to enable one of ordinary skill in the art to make and use the invention and is provided in the context of a patent application and its requirements. Various modifications to the preferred embodiments and the generic principles and features described herein will be readily apparent to those skilled in the art. For example, while the preferred embodiment is implemented in a handheld electronic device, those skilled in the art would appreciate that any electronic device having access to a wireless network would suffice. Thus, the present invention is not intended to be limited to the embodiments shown, but is to be accorded the widest scope consistent with the principles and features described herein.

According to a preferred embodiment of the present invention, a handheld electronic device, such as a PDA, mobile phone or navigation system, includes a locator, which when activated, allows a user of the device to access a wireless local area network (LAN) in order to locate services and products nearby. Local merchants or providers use the wireless LAN to broadcast advertising information about the services and products offered by the merchants/providers. The locator receives the advertising information and displays a reference to each merchant/provider to the user.

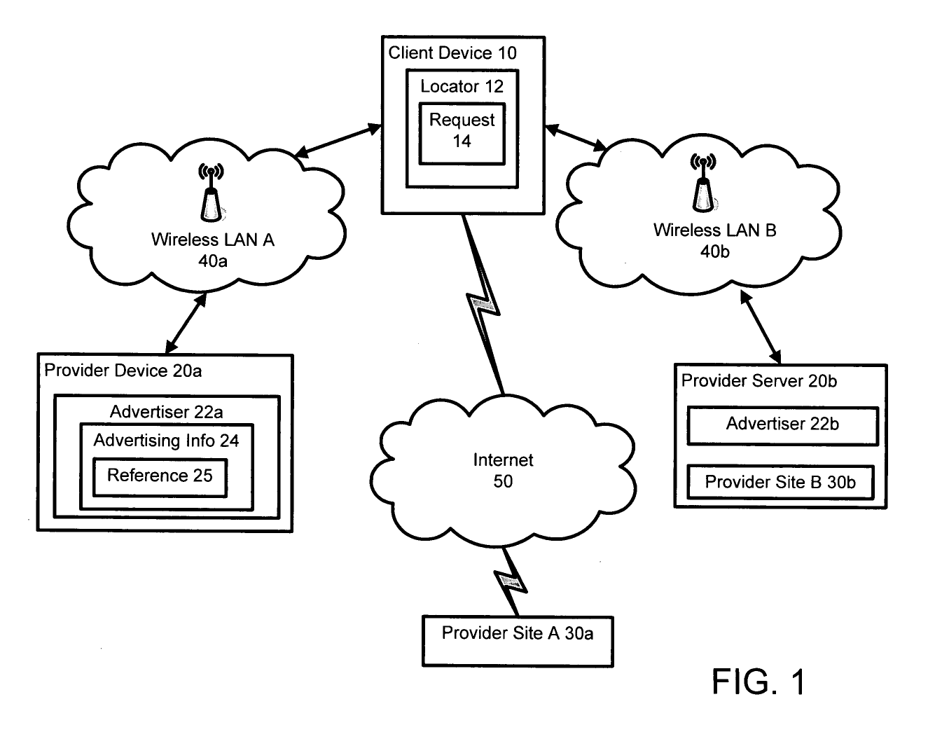

FIG. 1 is block diagram illustrating a network environment in which the preferred embodiment of the present invention can be implemented. A client device 10 includes a locator 12, which is preferably a software application that is capable of interacting with the device's transceiver. When activated by a user of the client device 10, the locator 12 connects the device 10 to local wireless networks 40a, 40b. According to a preferred embodiment of the present invention, the locator 12 provides a user interface that allows the user to specify a request 14 for services or products. The locator 12 also is enabled to receive advertising information transmitted from one or more local merchants and to display a reference associated with each of the local merchants.

As stated above, the client device 10 can be a handheld electronic device, such as a PDA or mobile phone or any other mobile electronic device such as a navigation system in a vehicle. The local networks 40a, 40b can be WiFi networks, WiFi broadband networks, BlueTooth networks and the like.

Provider devices 20a and provider servers 20b are also coupled to the local wireless networks 40a, 40b. A provider device 20a can be a computer system dedicated to a merchant/provider, while the provider server 20b can support at least one merchant/provider and typically hosts one or more provider websites 30b. The provider device 20a and server 20b include at least one advertiser 22a, 22b associated with one or more merchants/providers. The advertiser, e.g., 22a, allows an associated merchant/provider to transmit advertising information 24 to the client device 10 via the wireless network 40a.

In a preferred embodiment, the advertiser, e.g., 22b and associated provider site 30b can be co-resident in the same server 20b, or the advertiser 22a and the associated provider site 30a can be separated. Moreover, the advertiser 22a and the associated provider site 30a can be on the same or separate networks.

In another preferred embodiment, a merchant/provider can protect its LAN with a firewall (not shown) and expose only the advertiser 22b and the provider site address. Those skilled in the art will readily appreciate that a variety of network configurations can be implemented to allow the advertiser 22b to transmit advertising information 24 related to a merchant/provider to the client device 10, and that the embodiments shown and discussed above are illustrative and not intended to limit the scope of the present invention.

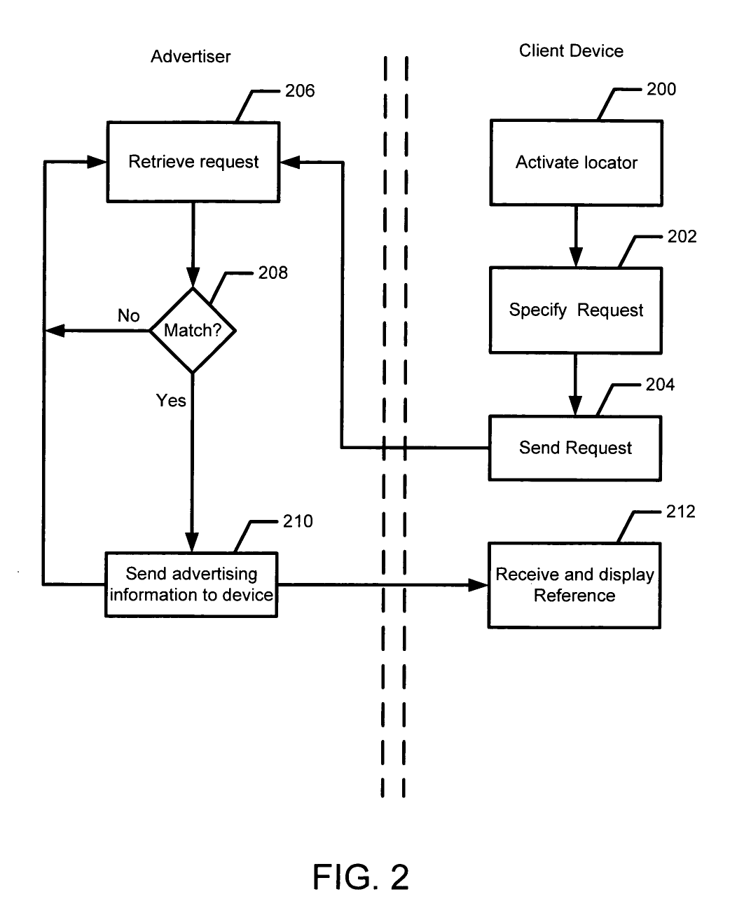

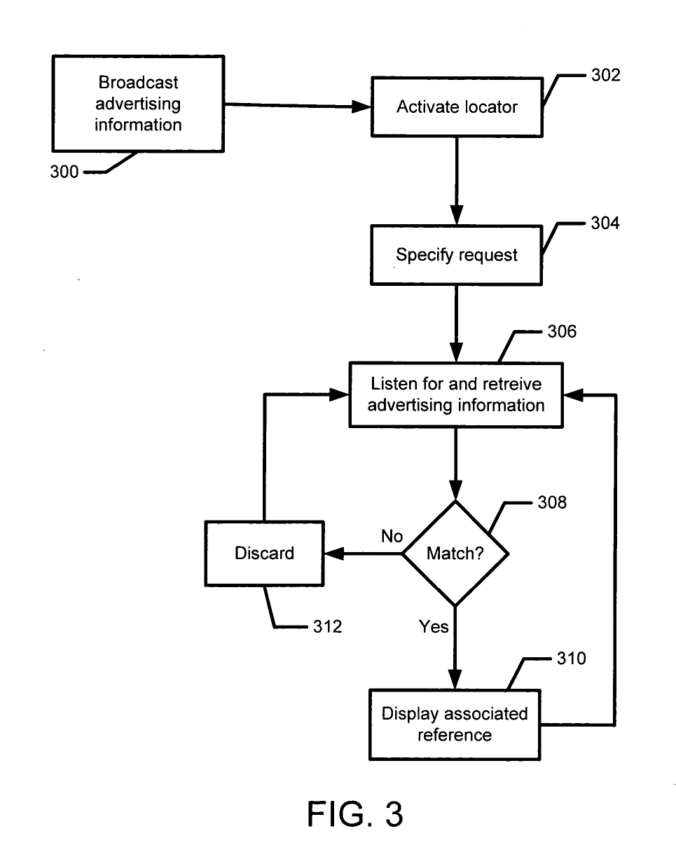

FIG. 2 and FIG. 3 are flowcharts illustrating how the locator 12 in the client device 10 interacts with the advertiser 22a, 22b. FIG. 2 is flowchart describing a process for collecting location sensitive information according to a first preferred embodiment of the present invention where the client device 10 issues a request over the wireless LANs 40a, 40b. Referring to FIG. 1 and FIG. 2, the process begins when the user activates the locator 12 in the client device 10 (step 200). Typically, the user will be walking or driving through a neighborhood and be interested in finding a restaurant or shop nearby. The user is allowed to specify a request 14 for a particular type of service/product, e.g., a restaurant or a shop (step 202) via a user interface (not shown) provided by the locator 12. Alternatively, the user can specify a request 14 for all nearby services and products.

Once the locator 12 is activated and the request 14 optionally specified, the locator 12 connects the client device 10 to the wireless LANs 40a, 40b that are accessible (as configured) and sends the request 14 to the wireless LANs 40a, 40b. The request 14 sent by the locator 12 is preferably broadcasted in a manner that is specific to the network type, e.g., to a well-known or configured broadcast address. In another preferred embodiment, the request 14 is sent to a well-known or configured address for the LAN 40a, 40b. In yet another embodiment, the request 14 is addressed to any address, but intercepted by a proxy (not shown) that processes the request 14. Alternative methods for broadcasting the request 14 will be apparent to those skilled in the art, and the scope of the present invention is not intended to be limited by those discussed above.

In the meantime, advertisers 22a, 22b are continuously listening for requests 14 from client devices 10 on the LANs 40a, 40b. When the client device 10 issues the specified request 14 (step 204) onto the LANs 40a, 40b, the advertisers 22a, 22b identify and retrieve the request 14 (step 206). In a preferred embodiment, the request 14 is formatted in such a way that the advertisers 22a, 22b are able to identify the request 14 by its formatting.

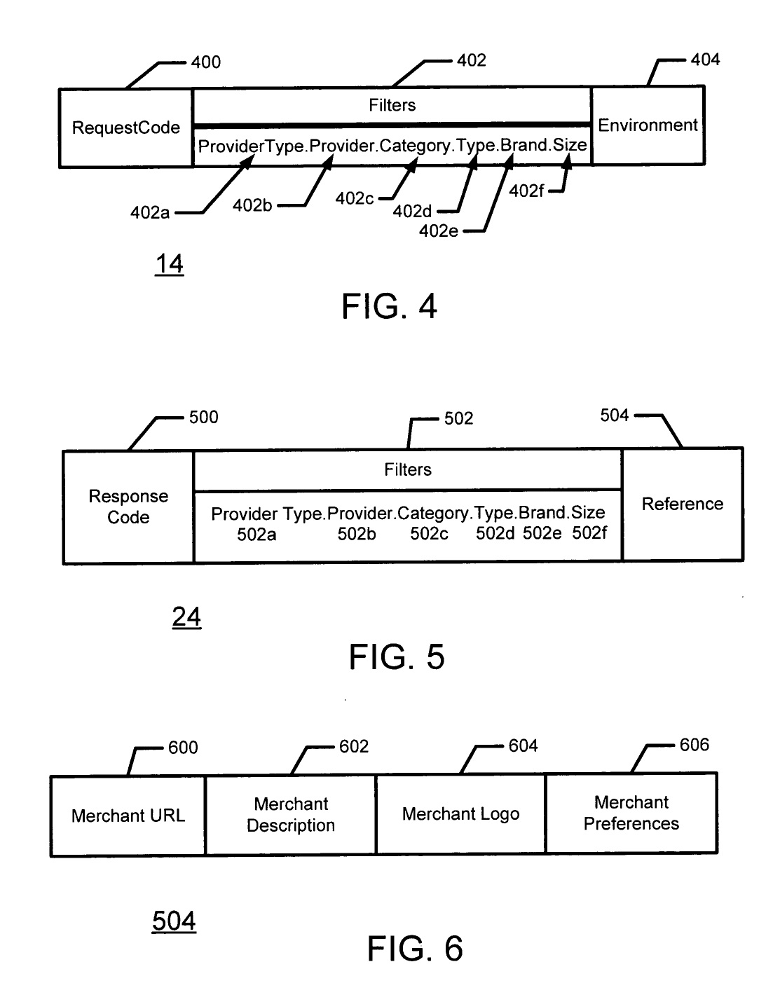

FIG. 4 is a block diagram illustrating a format for the request 14 according to a preferred embodiment of the present invention. As is shown, the request 14 includes a request code 400, a filter section 402 and a description of the electronic device's system environment 404. The request code 400 identifies the message as a request 14, and is preferably a character string such as “locate.” The format is extensible and, thus, supports additional request codes.

The filters section 402 specifies the product or service desired. In one embodiment, the filters section 402 includes a plurality of character strings separated by a delimiter, such as a period. Each of the character strings represents a feature describing the product or service. For example, a first string specifies the provider type 402a, e.g., “Restaurant”, “Printing”, “Cleaner”, “Hardware”, etc. The provider type 402a can be followed by a specific provider 402b, e.g., “Dominoes”, “Kinkos”, etc. Next a product or service category 402c can be specified, e.g., “Food”, “Paper”, “Pants”, and a type 402d, which further limits the product or service category 402c. For example, if “Food” is specified as a category, the type can be “Pizza.” If necessary, a brand 402e and a size 402f can be specified. Preferably, only relevant fields need be completed, and wildcards are allowed. For example, a request 14 for a pizza provider who sells pizza by the slice could be formatted as: “*.*.food.pizza.*.slice”

The environment section 404 of the request format 14 includes information about the electronic device's capabilities and operating environment. In one embodiment this section 404 includes keyword/value pairs that describe the environment. For example, the following keyword/value pairs: os=symbian; display=true; color=true; GUI=true; browser=true; indicate that the device includes a Symbian operating system, has a color display, and supports a browser. This information can be utilized by the advertiser 22a, 22b to customize the advertising information 24 it returns in response to the request 14.

Referring again to FIG. 2, once the request 14 has been received, the advertisers 22a, 22b determine whether the service or product offered by the associated merchant(s) match the request 14 (step 208). If a match is determined, the advertiser, e.g., 22a, sends advertising information 24 that includes a reference 25 to each associated matching merchant to the client device 10 (step 210).

FIG. 5 is a block diagram illustrating a format for the advertising information 24 according to a preferred embodiment of the present invention. The advertising information 24 is formatted to complement the request 14, and includes a response code 500, and a filters section 502 in addition to the reference 504. The response code 500 is similar to the request's response code 400, i.e., it identifies the message as advertising information 24, and is preferably a character string, such as “locate.” This is extensible and may support other response codes.

The filters section 502 specifies the product or service offered by the merchant similarly to how the request 14 specifies the product or service desired. Preferably, wildcards will not be utilized in the provider type 502a and provider 502b fields because merchants typically offer multiple products and services. The remaining fields, however, will often contain wildcards.

The reference 504 includes information related to the merchant. FIG. 6 is a block diagram illustrating information in the reference according to a preferred embodiment of the present invention. As is shown, the reference 504 includes one or a combination of the following: an address or URL 600 for the merchant; a description of the service(s) or product(s) offered 602; an icon or logo 604, and presentation/display preferences 606.

The merchant URL 600 preferably allows a potential customer to access the merchant, and may be provided in any number of formats. For example, the URL 600 may refer to the merchant's web page, a street address, a downloadable executable, etc. The advertiser 22a may provide different URLs to different devices depending on the information provided by each device. The description 602 is a text block, or alternatively, a URL that references the content of the section. Similarly, the logo section 604 includes an icon and/or includes a URL that identifies a location from which the icon is retrieved.

The merchant preferences section 606 describes how the advertising information should be displayed on the electronic device, and preferably includes keyword/value pairs. For example, consider the following keyword/value pairs: desktop=true; icon=true; flyover=true. These preferences indicate that the merchant requests that the device display the merchant's icon on the device's desktop, and that it display the description when the device UI's focus is on the icon. If the user selects the merchant's icon and a URL has been provided, the URL is accessed by the device. Other preferences include keywords which allow the merchant to request a menu item be added to the device main menu, or to request that a control, such as button, be added to the browser's toolbar on the device.

It should be apparent to those skilled in the art that the request and advertising information formats described above are exemplary and that equivalent formats are available which would provide the same capabilities. Accordingly, the principles of the present invention should be construed to encompass those equivalent formats.

Referring again to FIG. 2, after the advertiser 22a sends the advertising information 24 to the client device 10, the locator 12 in the device 10 receives and displays the reference(s) 504 (step 212). In a preferred embodiment, the locator 12 displays the reference(s) 504 according to the user's preferences, the device's 10 capabilities, and the display preferences of the merchant 606, if provided. As stated above, the request 14 can include the client device's capabilities and the user's preferences 404 (FIG. 4) so that the advertisers 22a, 22b can customize the reference(s) 504.

FIG. 3 is a flowchart illustrating a process for collecting location sensitive information according to a second preferred embodiment of the present invention where the advertisers 22a, 22b broadcast advertising information 24 over the wireless LANs 40a, 40b. Referring again to FIG. 1 and FIG. 3, the advertisers 22a, 22b are continuously broadcasting advertising information 24 onto the LANs 40a, 40b (step 300). In a preferred embodiment, the advertising information 24 includes the reference 504 to the merchant discussed above. When the user wants to find services or products nearby, the user activates the locator 12 in the client device 10 (step 302) and is allowed to specify a request 14 (step 304), as described above in step 202 of FIG. 2. In this mode, the filters section 402 is used to filter advertising information 24.

Once the locator 12 is activated and the request 14 optionally specified, the locator 12 connects the device 10 to the LANs 40a, 40b, and listens for and retrieves advertising information 24 broadcasted by the advertisers 22a, 22b (step 306). According to a preferred embodiment, the locator 12 identifies the advertising information 24 by analyzing the response code section 500 of the advertising information 24.

Once the locator 12 retrieves the advertising information 24 from the wireless LANs 40a, 40b, the locator 12 determines whether the service or product offered by the merchant(s) matches the request 14 (step 308). If a match is determined, the locator 12 displays the reference 504 associated with the matched merchant(s), which was included in the advertising information 24. The locator 12 then listens for more advertising information 24 (step 306) and steps 306 through 310 are repeated.

Through aspects of the preferred embodiment of the present invention, a handheld electronic device 10 can locate services and products nearby without having to provide location information. Local merchants who provide such services and products can advertise their services and products as they wish in the manner in which they design their respective websites, and utilize their own networks or a shared network to broadcast their advertisements, thereby eliminating the need for a third party directory service.

A method and system for distributing and collecting location sensitive information over a wireless local area network has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

1. A method for collecting location sensitive information over a wireless local area network by an electronic device comprising;
specifying a request for a product or service;
receiving advertising information related to a local merchant from the local merchant and transmitted over the wireless local area network (LAN); and
displaying the advertising information if a product or service offered by the local merchant matches the request, whereby the electronic device collects location sensitive information without requiring the electronic device to specify its location.

2. The method of claim 1, wherein the request is inherent to the electronic device.

3. The method of claim 1 further including providing a locator in the electronic device, which connects the electronic device to the wireless local area network (LAN).

4. The method of claim 3, wherein specifying the request includes allowing a user to specify the request via a user interface provided by the locator.

5. The method of claim 1 further including issuing the specified request over the wireless LAN by the electronic device.

6. The method of claim 5, wherein issuing the specified request includes transmitting the request to a well-known address for the wireless LAN.

7. The method of claim 5, wherein issuing the specified request includes transmitting the request to an address, intercepting the request by a proxy, and processing the request.

8. The method of claim 5 further including receiving the specified request by the local merchant coupled to the wireless LAN and determining whether a product or service provided by the local merchant matches the request.

9. The method of claim 8 further including, if the product or service provided by the local merchant matches the request, transmitting the advertising information related to the local merchant to the electronic device via the wireless LAN.

10. The method of claim 1, wherein the advertising information describes a product or service offered by the local merchant and includes a reference to the local merchant.

11. The method of claim 10, wherein the reference includes a URL for the local merchant.

12. The method of claim 10, wherein the reference includes an icon, which when selected by the user, provides additional data related to the local merchant.

13. The method of claim 1 further including listening to the wireless LAN by the electronic device for advertising information related to the local merchant, retrieving such information and determining whether a product or service provided by the local merchant matches the specified request.

14. The method claim 10, wherein displaying the advertising information includes displaying the reference to the local merchant.

15. A system for distributing and collecting location sensitive information over a wireless local area network comprising:
a computer system associated with at least one local merchant, wherein the computer system is coupled to the wireless local area network (LAN) and includes at least one advertiser for transmitting over the wireless LAN advertising information related to each of the at least one local merchants; and
an electronic device capable of connecting to the wireless LAN, comprising:
a locator for connecting the electronic device to the wireless LAN and for receiving the advertising information transmitted by the computer system associated with the at least one merchant; and
a display for displaying the advertising information if a product or service offered by a local merchant matches a request from the electronic device for a product or service,
wherein the electronic device collects location sensitive information without having to specify its location.

16. The system of claim 15, wherein the request is inherent to the electronic device.

17. The system of claim 15 wherein the locator provides a user interface for allowing a user to specify the requested product or service.

18. The system of claim 15, wherein the locator issues the specified request over the wireless LAN.

19. The system of claim 18, wherein the locator issues the specified request by transmitting the request to a well-known address for the wireless LAN.

20. The system of claim 18, wherein a proxy intercepts the specified request and processes the request.

21. The system of claim 18, wherein the computer system receives the specified request and the at least one advertiser determines whether a product or service provided by any of the at least one local merchants matches the request.

22. The system of claim 21, wherein if the product or service provided by any of the at least one local merchants matches the request, the at least one advertiser transmits the advertising information related to each of the local matching merchants to the electronic device via the wireless LAN.

23. The system of claim 15, wherein the advertising information for a local merchant describes a product or service offered by the local merchant and includes a reference to the local merchant.

24. The system of claim 15, wherein the locator listens to the wireless LAN for advertising information related to the local merchant, retrieves such information and determines whether a product or service provided by the local merchant matches the request.

25. The system of claim 23, wherein the display displays the reference to the local matching merchant.

26. The system of claim 23, wherein the reference includes a URL for the associated local merchant.

27. The system of claim 23, wherein the reference includes an icon, which when selected by the user, provides additional data related to the associated local merchant.

28. The system of claim 15, wherein the electronic device is a mobile handheld electronic device.

29. A method for distributing from a local merchant advertising information to a potential customer over a wireless local area network comprising:
receiving by the local merchant a request for a product or service transmitted over the wireless local area network (LAN) by the potential customer;
determining whether a product or service offered by the local merchant matches the request; and
if the local merchant's product or service matches the request, transmitting advertising information from the local merchant to the potential customer, wherein the advertising information describes the product or service offered by the local merchant and includes a reference to the local merchant,
whereby the local merchant distributes advertising information directly to potential customers and eliminates the need for a third party directory service.

30. The method of claim 29 further including allowing the local merchant to design the reference according to the local merchant's preferences.

31. The method of claim 29, wherein the reference includes a URL for the local merchant.

32. The method of claim 29, wherein the reference includes an icon, which when selected by the potential customer, provides additional data related to the local merchant.
